(19) United States
(12) Patent Application Publication
(10) Pub. No.: US 2011/0103885 A1
(43) Pub. Date: May 5, 2011

(54) Retaining Device for Tube Member

(76) Inventor: Jin-Cang Li, Fusing Township (TW)

(21) Appl. No.: 12/814,380

(22) Filed: Jun. 11, 2010

(30) Foreign Application Priority Data
Nov. 5, 2009 (TW) 098220498

(51) Int. Cl. F16B 7/00

(52) U.S. Cl. 403/316

(57) ABSTRACT

A retaining device for a tube member contains a body including a peripheral fringe and a side fringe connected together to define a receiving space, the receiving space including a first and a second sides, the peripheral fringe including a first engaging portion defined thereon, including a first connecting portion and a fixed portion connected with two ends of the first engaging portion respectively; a movable retaining member installed in the receiving space, and including a second engaging portion, and including a second connecting portion and a movable portion connected with two ends of the second engaging portion respectively, the second connecting portion being used to connect with the first connecting portion of the body; a locking element being used to force the moving portion toward the fixed portion of the body so that the external fence is retained tightly between the first locking fences and the locking fences.

### BACKGROUND OF THE INVENTION

1. Field of the Invention

The present invention relates to a retaining device for a tube member.

2. Description of the Prior Art

A conventional retaining device for a tube member is used on a bicycle and designed in two different types. For example, the retaining device is inserted through an outer wall of a metal engaging member by using a force bolt, and the force bolt is fitted on an external fence of a handlebar in the metal engaging member. However, a certain portion of the external fence of the handlebar where is biased against by a distal end of the force bolt generates stress to cause a deformation on the external fence of the handlebar. Moreover, a nut end of the force bolt exposes outside due to the metal engaging is thin, having a poor aesthetics appearance and injuring user's hands easily. Another conventional retaining device includes a locking bolt locked on an opening of an elongated gap around the metal engaging member so that the metal engaging member is fitted to an outer external fence of a handlebar, however, the elongated gap of the retaining device causes a poor aesthetics appearance and injures user's hands easily. Besides, the metal engaging member is formed in a C shape that will have a mouth without a closed wall, therefore the tube member can not be used as an end plug. Also, the metal engaging member can not have an enough space to install other components, such as a warning unit, etc.

The present invention has arisen to mitigate and/or obviate the afore-described disadvantages.

### SUMMARY OF THE INVENTION

The primary object of the present invention is to provide a retaining device for a tube member which is capable of overcoming the shortcomings of the conventional retaining device for a tube member thereof.

Secondary object of the present invention is to provide a retaining device for a tube member that can apply a retaining force in circumferential direction to retain a grip on the tube member securely, and when the retaining device, the tube member, and the grip are connected together, an inner end of the retaining device contacts with an outer end of the grip so that the retaining device is not exposed outside to achieve aesthetics appearance.

Further object of the present invention is to provide a retaining device for a tube member that the peripheral fringe is not provided with an elongated gap as a conventional retaining device to have aesthetics appearance and holding comfort.

Another object of the present invention is to provide a retaining device for a tube member that the retaining device is designed in a different shape from that of the first embodiment, and a length of the grip is different from that of the first embodiment so that when the retaining device is installed on the tube member of the handlebar of the bicycle, the retaining device with the grip is used as an auxiliary handle so that the user maintains different postures based on requirement.

To obtain the above objectives, a retaining device for a tube member provided by the present invention comprises

a body including a peripheral fringe and a side fringe connected with each other to define a receiving space, the receiving space including a first side and a second side, the peripheral fringe including a first engaging portion defined on a predetermined position thereof relative to the first side, and including a first connecting portion and a fixed portion connected with two ends of the first engaging portion respectively;

a movable retaining member installed in the receiving space of the body relative to the second side, and including a second engaging portion relative to the first engaging portion, and including a second connecting portion and a movable portion connected with two ends of the second engaging portion respectively, the second connecting portion being used to connect with the first connecting portion of the body;

a locking element being used to force a moving portion of the movable retaining member toward the fixed portion of the body so that an external fence of the tube member is retained tightly between a first locking fences of the first engaging portion and a second locking fences of the second engaging portion.

### BRIEF DESCRIPTION OF THE DRAWINGS

FIG. 1 is a perspective view showing the operation of a retaining device for a tube member according to a first embodiment of the present invention;

FIG. 2 is a perspective view showing the exploded components of a part of the retaining device for the tube member according to the first embodiment of the present invention;

FIG. 3 is a perspective view showing the exploded components of the retaining device for the tube member according to the first embodiment of the present invention;

FIG. 4 is another perspective view showing the exploded components of the retaining device for the tube member according to the first embodiment of the present invention;

FIG. 5 is a side plan view showing the assembly of a body of the retaining device for the tube member according to the first embodiment of the present invention;

FIG. 6 is a side plan view showing the assembly of the retaining device for the tube member according to the first embodiment of the present invention;

FIG. 7 is another side plan view showing the assembly of the retaining device for the tube member according to the first embodiment of the present invention;

FIG. 8 is a perspective view showing the assembly of a body of a retaining device for a tube member according to a second embodiment of the present invention;

FIG. 9 is another perspective view showing the assembly of the body of the retaining device for the tube member according to the second embodiment of the present invention;

FIG. 10 is a perspective view showing the assembly of a body of a retaining device for a tube member according to a third embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

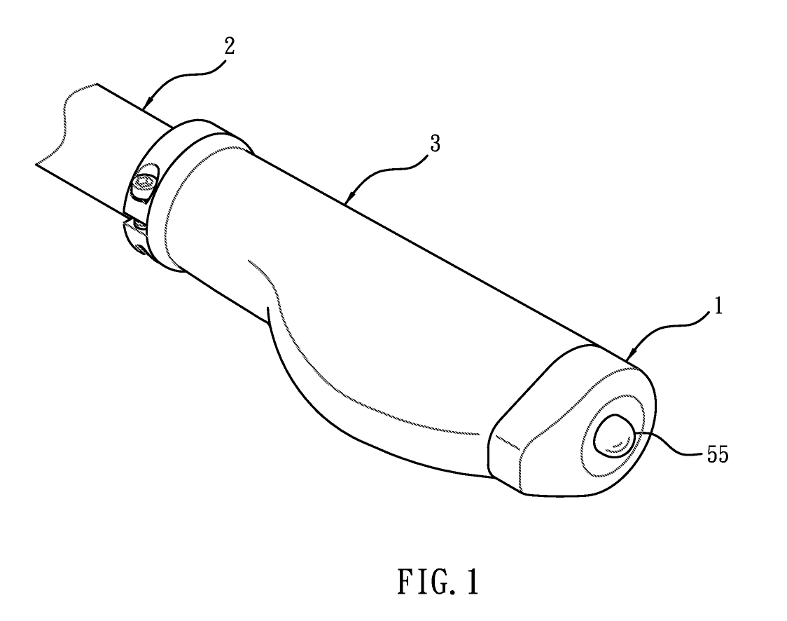

Referring to FIGS. 1-4, a retaining device 1 for a tube member according to a first embodiment of the present invention is used to retain a grip 3 on the tube member 2 and emit a warning light, wherein the tube member 2 is a handlebar of a bicycle, and the grip 3 includes two positioning projections 3a extending outward form an outer side thereof. The retaining device 1 comprises a body 10, a movable retaining member 20, a locking element 30, a housing 40, and a warning unit 50.

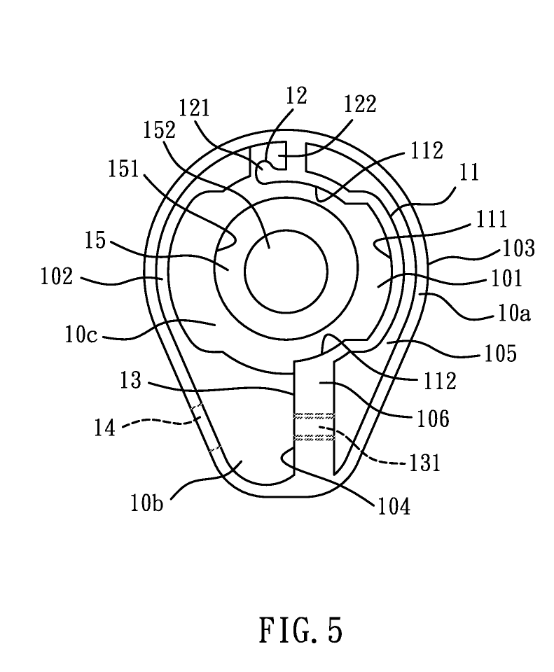

The body 10, as shown in FIG. 5, includes a peripheral fringe 10a and a side fringe 10b connected with each other to define a receiving space 10c, the receiving space 10c includes a first side 101 and a second side 102, the peripheral fringe 10a includes a first engaging portion 11 defined on a predetermined position thereof relative to the first side 101, and includes a first connecting portion 12 and a fixed portion 13 connected with two ends of the first engaging portion 11 respectively.

The peripheral fringe 10a includes a recessed portion 105 defined between an outer fringe 103 and an inner fringe 104 to be worked easily and to lower weight, and includes an inner fringe 106 integrally extending from a predetermined position thereof relative to the first side 101, and the inner fringe 106 is comprised of the first engaging portion 11, the first connecting portion 12, and the fixing portion 13.

The first engaging portion 11 of the inner fringe 106 is formed in a C shape and includes a first fixing groove 111, the first fixing groove 111 includes two arcuate first locking fences 112 formed on two ends thereof individually, wherein the first fixing groove 111 is used to retain the positioning projection 3a, and the first locking fence 112 is fitted onto an external fence 2a of the tube member 2.

The first connecting portion 12 of the inner fringe 106 includes a first hook 121 and a slot 122 defined above the first hook 121, wherein the slot 122 is formed in a hook shape and comprised of the first hook 121 and the inner fringe 104.

The fixing portion 13 of the inner fringe 106 is a flat and straight wall and includes a hole 131 disposed thereon.

The peripheral fringe 10a includes an aperture 14 mounted on a predetermined position thereof relative to the second side 102 to correspond to the hole 131.

The peripheral fringe 10a in the receiving space 10c of the body 10 includes a circular trench 15, and the trench 15 includes inner screws 151 fixed on an inner surface thereof and a circular orifice 152 formed on a center thereof.

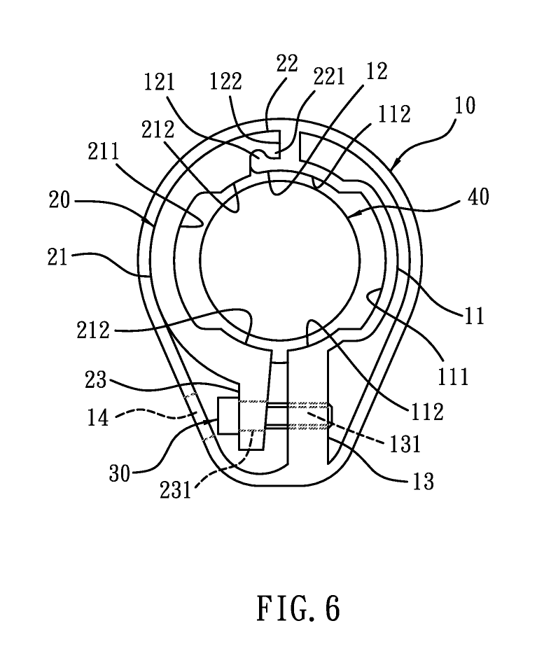

The movable retaining member 20, as illustrated in FIG. 6, is installed in the receiving space 10c of the body 10 relative to the second side 102, and includes a second engaging portion 21 relative to the first engaging portion 11, and includes a second connecting portion 22 and a movable portion 23 connected with two ends of the second engaging portion 21 respectively, the second connecting portion 22 is used to connect with the first connecting portion 12 of the body 10.

The movable retaining member 20 includes a C-shaped wall and a flat and straight wall extending from one end of the C-shaped wall, and the second engaging portion 21 is located at the C-shaped wall and includes two arcuate second locking fences 212 formed on two ends thereof individually, wherein a second fixing groove 211 is used to retain another positioning projection 3a, and the second locking fences 212 is fitted onto the external fence 2a of the tube member 2.

The second connecting portion 22 is located above the C-shaped wall and includes an integrally formed second hook 221 to match with the slot 122 so as to retain into the slot 122 and engage with the first hook 121 so that one end of the movable retaining member 20 engages with and disengages from the body 10.

The movable portion 23 is located at the flat and straight wall and includes an opening 23 arranged thereon to correspond to the aperture 14 and the hole 131.

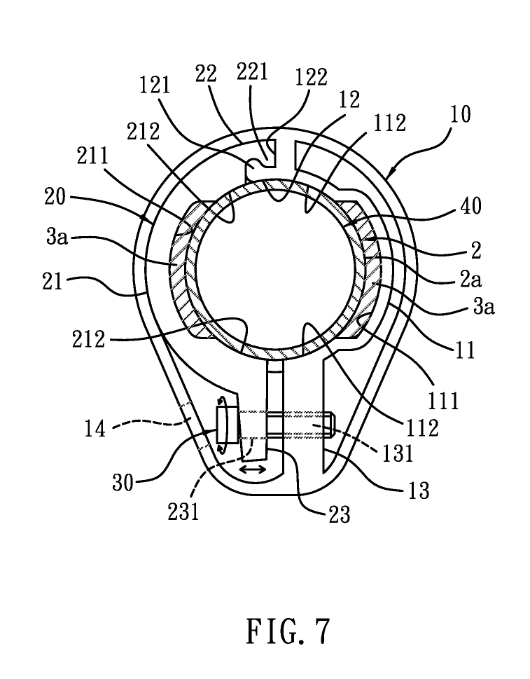

The locking element 30 as shown in FIGS. 6 and 7 is used to force the moving portion 23 of the movable retaining member 20 toward the fixed portion 13 of the body 10. In this embodiment, the locking element 30 is a bolt to be inserted into a bore 231 of the moving portion 23 of the movable retaining member 20 through the aperture 14 of the body 10 so as to screw with the hole 131 of the fixed portion 13 of the body 10 by using an alien wrench or a screw driver, when the bolt is rotated tightly, the movable portion 23 is moved toward the fixed portion 13 by a force which rotates the bolt tightly, and the second engaging portion 21 moves toward the first engaging portion 11 and deforms lightly, such that the external fence 2a of the tube member 2 is retained tightly between the first locking fences 112 of the first engaging portion 11 and the second locking fences 212 of the second engaging portion 21 so that the retaining device 1 is retained on a distal end of the tube member 2, and the positioning projections 3a of the grip 3 is retained between the first fixing groove 111 of the first engaging portion 11, the second fixing groove 211 of the second engaging portion 21, and the external fence 2a of the tube member 2 so that the grip 3 is fixed on the tube member 2 securely.

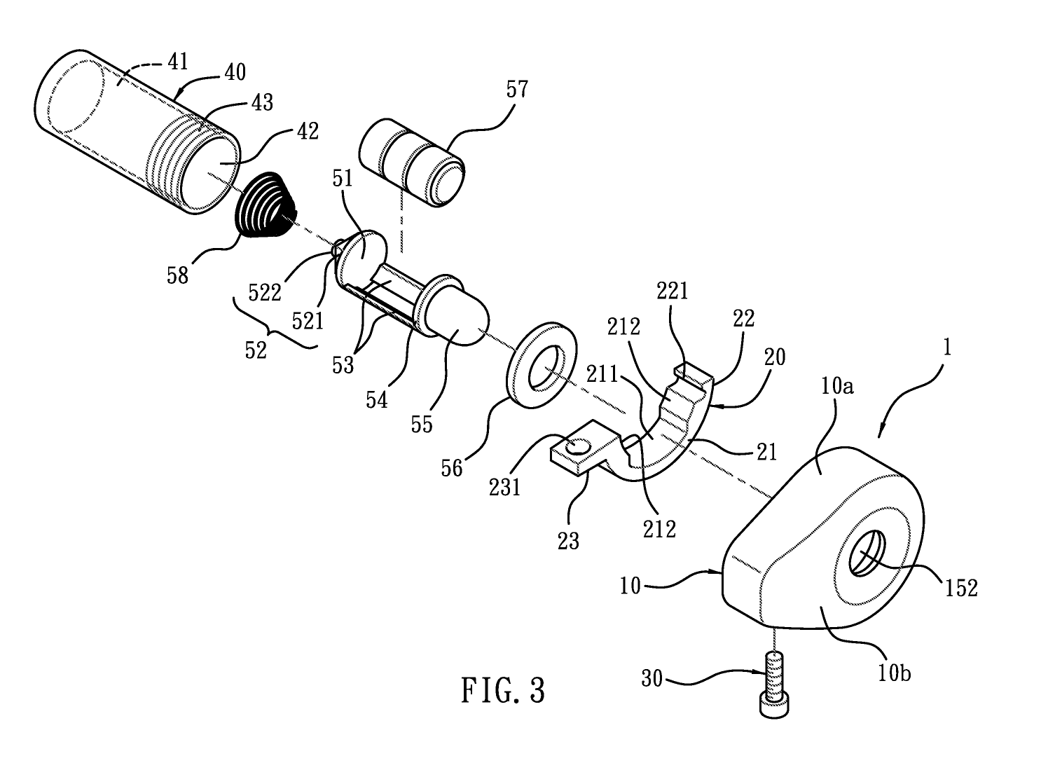

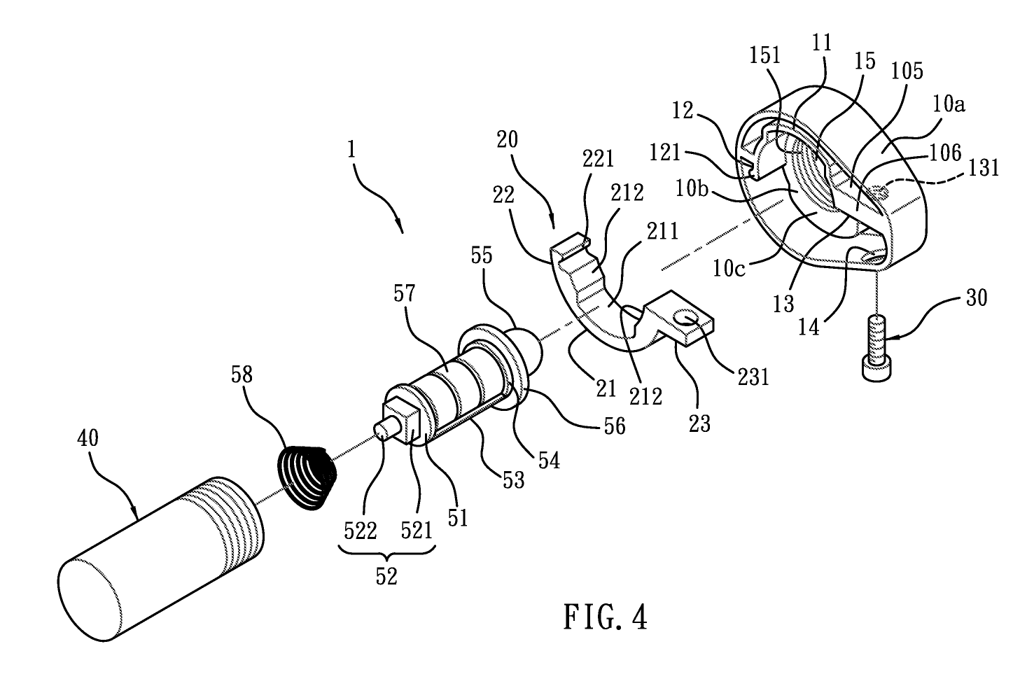

The housing 40 as shown in FIGS. 3 and 4 is formed in a cylinder shape and includes an inner room and a mouth 42, and the mouth 42 includes outer screws 43 arranged on an outer rim of one end thereof to screw with the inner screws 151 of the trench 15, and the housing 40 is received in the receiving space 10c from the distal end of the tube member 2.

The warning unit 50, as shown in FIGS. 3-4, comprises a circuit board 51, a contact switch 52 electrically connected on the circuit board 51, a LED holder 54 electrically connected with the circuit board 51 by using two electricity conducting members 53, a LED light 55 fixed on the LED holder 54, a waterproof pad 56 fitted on the LED light 55, a plurality of cells 57 installed on the electricity conducting members 53 and electrically connected with the circuit board 51 and the LED holder 54, a resilient element 58 (the resilient element 58 is a compression spring), wherein the cell 57 is provided to supply power to the circuit board 51 and the LED light 55, the contact switch 52 further comprises a base 521 and a button 522 installed on the base 521 to be pressed; one end of the resilient element 58 is abutted against a bottom end of an inner chamber 41, and another end of the resilient element 58 is fitted to the button 522 and is biased against the base 521. The waterproof pad 56 is elastically retained between an inner surface between the LED holder 54 and the circular orifice 152 of the body 10, e.g., on a bottom end of the circular trench 15 so that rains or waters can not permeate from the orifice 152 to obtain a waterproof effect.

The warning unit 50 is installed in the inner chamber 41 of the housing 40, and when the housing 40 is screwed with the trench 15 of the body 10, the LED holder 54 abuts against a bottom surface of the body 10 by ways of the resilient element 58, and the LED light 55 extends out of the orifice 152 from the body 10 to be pressed by a user. When the LED holder 54 is pressed, the contact switch 52 is actuated to move inward so that the button 522 of the contact switch 52 is biased against by the inner chamber 41 of the housing 40 to move inward, and the LED light 55 is turned on to emit warning light. Also, when the LED light 55 is pressed once more, the LED light 55 is switched to different-color lights or tuned off. It is to be noted that switching colors or emitting order of the LED light 55 is controlled by designing circuit but is not limited by using above-mentioned controlling method.

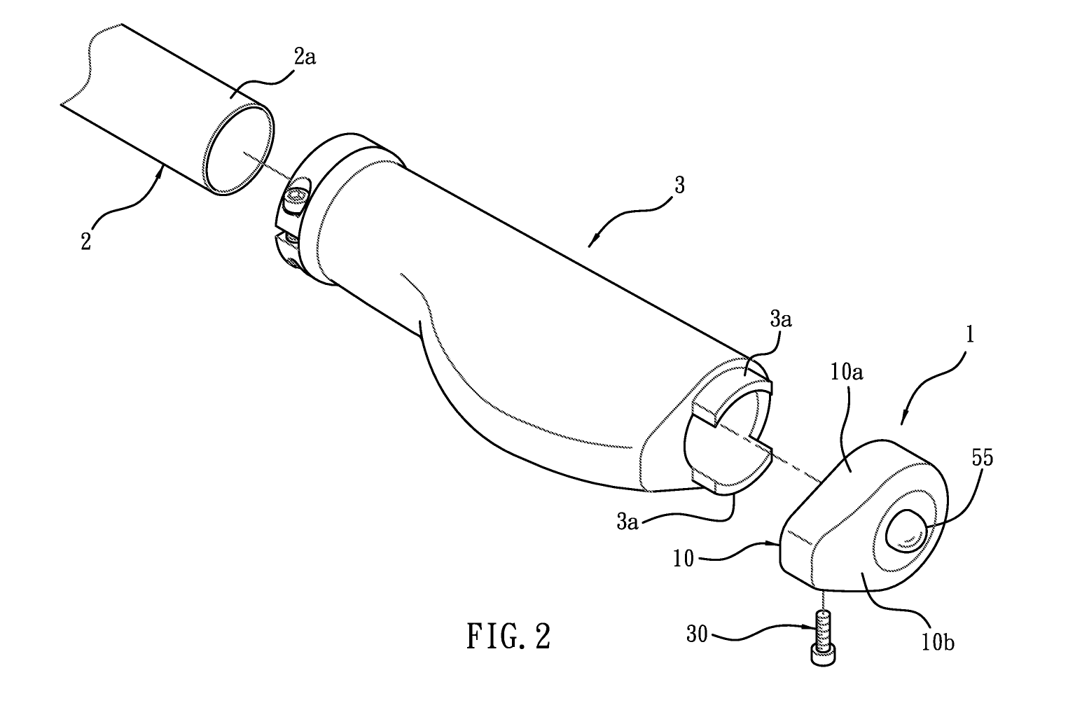

The peripheral fringe 10a of the retaining device 1 is formed in a certain shape to correspond to the grip 3. Referring to FIG. 2, when the retaining device 1, the tube member 2, and the grip 3 are connected together, an inner end of the retaining device 1 contacts with an outer end of the grip 3 so that the retaining device 1 is not exposed outside to achieve aesthetics appearance. Besides, the peripheral fringe 10a is not provided with an elongated gap as a conventional retaining device to have aesthetics appearance and holding comfort.

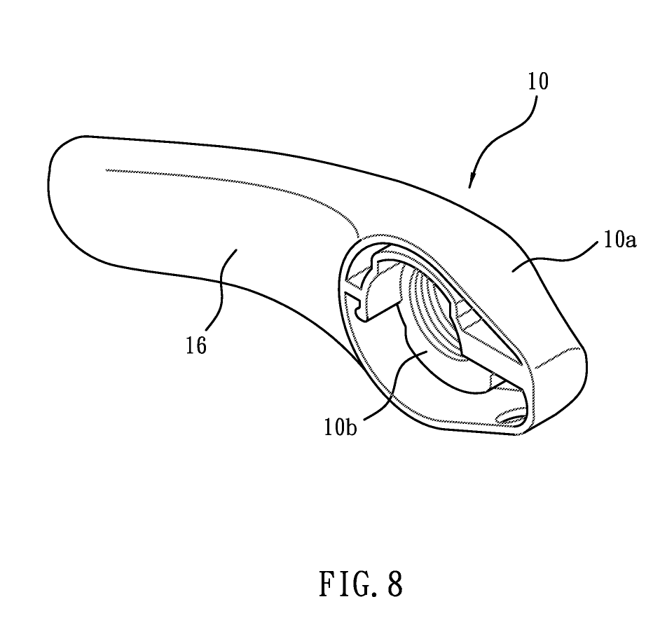

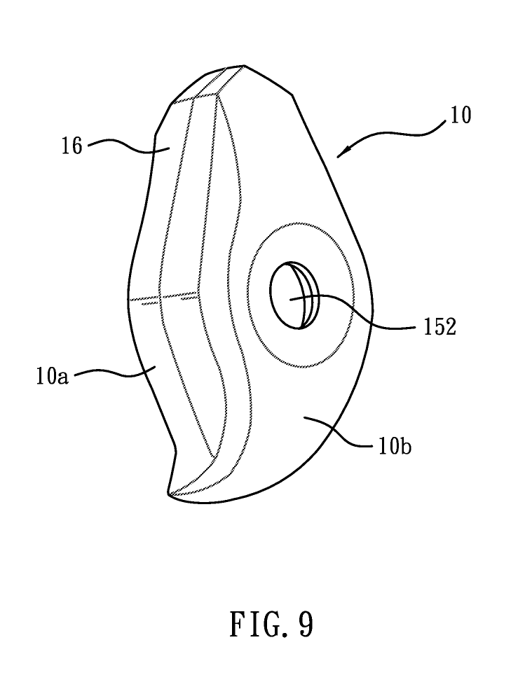

With reference to FIGS. 8 and 9, a difference of a retaining device according to a second embodiment of the present invention from that of the first embodiment comprises a body 10 including a peripheral fringe 10a, and the peripheral fringe 10a including a grip 16 integrally extending therefrom or coupled thereon, wherein the retaining device 1 of the second embodiment is designed in a different shape from that of the first embodiment, and a length of the grip 16 is different from that of the first embodiment so that when the retaining device 1 is installed on the tube member 2 of the handlebar of the bicycle, the retaining device 1 with the grip 16 is used as an auxiliary handle so that the user maintains different postures based on requirement.

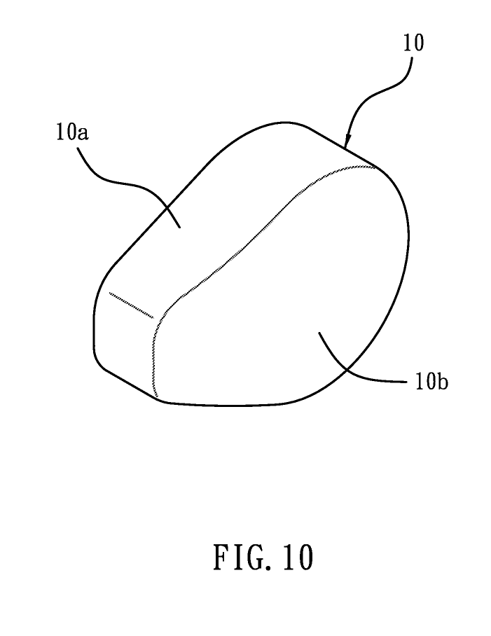

With reference to FIG. 10, a difference of a retaining device according to a third embodiment of the present invention from that of the first embodiment comprises a body 10 including a side fringe 10b, and the side fringe 10b is a closed surface, the retaining device is not provided with the housing 40 and the warning unit 50 of the first embodiment, and the trench 15 is not necessary in the third embodiment, hence when the retaining device 1 is installed on a tube member 2, the side fringe 10b is used as a closed retaining device 1 and an end plug.

The retaining devices 1 of the first, the second, and the third embodiments are served as an engaging component to retain an outer end of the grip 3 on the tube member 2 and the LED holder, the auxiliary handle or the end plug, wherein the retaining device 1 is used as the LED holder and the auxiliary handle simultaneously or the auxiliary handle and the end plug simultaneously. Of course, the retaining device 1 is also used as the LED holder, the auxiliary handle, and the end plug respectively instead of the engagement component of the grip 3. In the meantime, the first fixing groove 111 and the second fixing groove 211 are not required.

While we have shown and described various embodiments in accordance with the present invention, it is clear to those skilled in the art that further embodiments may be made without departing from the scope of the present invention.

What is claimed is:

1. A retaining device for a tube member comprising
a body including a peripheral fringe and a side fringe connected with each other to define a receiving space, the receiving space including a first side and a second side, the peripheral fringe including a first engaging portion defined on a predetermined position thereof relative to the first side, and including a first connecting portion and a fixed portion connected with two ends of the first engaging portion respectively;
a movable retaining member installed in the receiving space of the body relative to the second side, and including a second engaging portion relative to the first engaging portion, and including a second connecting portion and a movable portion connected with two ends of the second engaging portion respectively, the second connecting portion being used to connect with the first connecting portion of the body;
a locking element being used to force a moving portion of the movable retaining member toward the fixed portion of the body so that an external fence of the tube member is retained tightly between a first locking fences of the first engaging portion and a second locking fences of the second engaging portion.

2. The retaining device for the tube member as claimed in claim 1, wherein the first connecting portion includes a first hook and a slot defined above the first hook, the second connecting portion includes an integrally formed second hook to match with the slot so as to retain into the slot and engage with the first hook.

3. The retaining device for the tube member as claimed in claim 1, wherein the fixing portion of the body the includes a hole disposed thereon; the movable portion of retaining member includes an opening arranged thereon; the locking element is a bolt to be inserted through a bore of the moving portion through the aperture of the body to screw with the hole of the fixed portion so that the movable portion displaces toward the fixed portion.

4. The retaining device for the tube member as claimed in claim 3, wherein the peripheral fringe of the body includes an aperture mounted on a predetermined position thereof relative to the second side to correspond to the hole so that the bolt is rotated tightly and releasably via the aperture by using a tool.

5. The retaining device for the tube member as claimed in claim 1, wherein the first engaging portion of the inner fringe includes a first fixing groove, the first fixing groove includes two arcuate first locking fences formed on two ends thereof individually, wherein the first fixing groove is used to retain the positioning projection, and the first locking fence is fitted onto an external fence of the tube member, so that the grip is fixed on the tube member securely.

6. The retaining device for the tube member as claimed in claim 1, wherein the second engaging portion includes at least one arcuate second locking fence formed on two ends thereof individually, and the second fixing groove is used to retain another positioning projection, and the positioning projections is retained between the second fixing groove of the second engaging portion, and the external fence of the tube member so that the grip is fixed on the tube member securely.

7. The retaining device for the tube member as claimed in claim 1 further comprising a housing and a warning unit; the housing is received in the receiving space from the distal end of the tube member; the warning unit is installed in the housing and includes a LED light to be power on by pressing the LED light, the peripheral fringe includes a circular orifice formed on a center thereof so that the LED light extends out of the orifice from the body to be pressed by a user.

8. The retaining device for the tube member as claimed in claim 7, wherein the warning unit includes a circuit board, a contact switch electrically connected on the circuit board, a LED holder electrically connected with the circuit board by using two electricity conducting members, at least one cell installed on the electricity conducting members and electrically connected with the circuit board and the LED holder, a resilient element, wherein the LED light is fixed on the LED holder, one end of the resilient element is abutted against a bottom end of an inner chamber, and another end of the resilient element is fitted to the button so that the LED holder abuts against a bottom surface of the body by ways of the resilient element, and the LED light extends out of the orifice from the body to be pressed by a user, so when the LED holder is pressed, the contact switch is actuated to move inward so that the button of the contact switch is biased against by the inner chamber of the housing to move inward, and the LED light is turned on to emit warning light.

9. The retaining device for the tube member as claimed in claim 8, wherein the contact switch further comprises a base and a button installed on the base to be pressed; the resilient element is a compression spring and another end of the resilient element is biased against the base.

10. The retaining device for the tube member as claimed in claim 8, wherein the warning unit includes a waterproof pad fitted on the LED light, and the waterproof pad is elastically retained between an inner surface between the LED holder and the circular orifice of the body.

11. The retaining device for the tube member as claimed in claim 7, wherein the housing includes outer screws arranged on an outer rim of one end thereof; the peripheral fringe in the receiving space of the body includes a circular trench, and the trench includes inner screws fixed on an inner surface thereof to screw with the outer screws of the housing.

12. The retaining device for the tube member as claimed in claim 1, wherein the peripheral fringe including a grip 16 integrally extending therefrom or coupled thereon so that the grip is used as an auxiliary handle.

13. The retaining device for the tube member as claimed in claim 1, wherein the side fringe of the body is used as a closed and an end plug.
